(19) United States
(12) Patent Application Publication
(10) Pub. No.: US 2026/0269955 A1
(43) Pub. Date: Sep. 10, 2026

(54) A METHOD FOR ENABLING MITIGATION OF INTERFERENCE AT A WIRELESS DEVICE, A RELATED NETWORK NODE, AND A RELATED WIRELESS DEVICE

(71) Applicant: Sony Group Corporation, Tokyo (JP)

(72) Inventors: Jose FLORDELIS, Lund (SE); Kun ZHAO, Malmö (SE); Erik BENGTSSON, Eslöv (SE); Fredrik RUSEK, Eslöv (SE)

(21) Appl. No.: 19/165,362

(22) PCT Filed: Mar. 18, 2024
(86) PCT No.: PCT/EP2024/057128

§ 371 Date: Sep. 15, 2025

(30) Foreign Application Priority Data
Mar. 30, 2023 (SE) 2350370-9

(51) Int. Cl. H04B 15/00; H04W 52/24

(52) U.S. Cl. CPC H04B 15/00; H04W 52/243

(57) ABSTRACT

Disclosed is a method, performed by a network node, for enabling mitigation of interference at a first wireless device. The interference is caused by a first signal intended for a second wireless device served by the network node. The method comprises transmitting the first signal, to the first wireless device, using a first gain associated with a first channel between the network node and the first wireless device. The method comprises transmitting the first signal, to the first wireless device, via a coverage enhancing device, CED, using a third gain associated with a third channel between the network node and the first wireless device via the CED. The method comprises transmitting to the second wireless device, using a second gain associated with a second channel between the network node and the second wireless device. The first gain, the second gain, and the third gain are jointly determined.

The present disclosure pertains to the field of wireless communications. The present disclosure relates to a method for enabling mitigation of interference at a wireless device, a related network node, and a related wireless device.

### BACKGROUND

Interferences can affect performance of communication in a wireless communication system. For example, in a wireless communication system using a Non-Orthogonal Multiple Access, NOMA, the interference may have even a stronger impact of the performance at the wireless device.

### SUMMARY

There is a need for techniques of interference management and mitigation. Certain interference mitigation techniques come with a significant overhead penalty.

Accordingly, there is a need for devices and methods for interference mitigation, which may mitigate, alleviate, or address the shortcomings existing and may provide interference management and mitigation with a limited overhead.

Disclosed is a method, performed by a network node, for enabling mitigation of interference at a first wireless device. The interference is caused by a first signal intended for a second wireless device served by the network node. The method comprises transmitting the first signal, to the first wireless device, using a first gain associated with a first channel between the network node and the first wireless device, via a coverage enhancing device, CED, using a third gain associated with a third channel between the network node and the first wireless device via the CED, and to the second wireless device, using a second gain associated with a second channel between the network node and the second wireless device. The first gain, the second gain, and the third gain are jointly determined.

Further, a network node is disclosed. The network node comprises memory circuitry, processor circuitry, and a wireless interface. The network node is configured to perform any of the methods disclosed herein.

It is an advantage of the present disclosure that the disclosed network node and method enable a wireless device, being a victim of interference from the network node, to mitigate the interference by interference decoding and cancellation (such as successive interference cancellation). The disclosed network node and method enable interference mitigation at the wireless device with a limited overhead in signalling. The disclosed network node does not need complete channel state information of the first and third channel to perform the disclosed technique. The disclosed network node may benefit from a power consumption that is reduced by activating the CED assistance for enabling interference decoding at the wireless device, compared to without the CED assistance.

Disclosed is a method, performed by a first wireless device, for mitigating interference at the first wireless device caused by a first signal intended for a second wireless device served by a first network node. The method comprises receiving a signal. The received signal is based on the first signal received from the first network node directly and via a coverage enhancing device, CED, and a second signal received from a second network node. The second signal comprises data intended for the first wireless device. The method comprises performing interference decoding on the received signal by applying an interference decoding procedure to the received signal.

Further, a wireless device is disclosed. The wireless device comprises memory circuitry, processor circuitry, and a wireless interface. The wireless device is configured to perform any of the methods disclosed herein.

It is an advantage of the present disclosure that the disclosed wireless device and method enable decoding and cancellation of interference (such as successive interference cancellation) from a network node not serving the wireless device. This may be particularly advantageous in a NOMA-based system where multiple wireless devices share the same time and/or frequency resource. The disclosed wireless device may benefit from an improved wireless performance in cases where the disclosed wireless device would otherwise not be able to communicate due to a limitation of a power budget at the network node.

Disclosed is a method, performed by a network node, for enabling mitigation of interference at a first wireless device. The interference is caused by a first signal intended for a second wireless device served by the network node via a second channel. The method comprises receiving an indication that the first wireless device experiences interference over a first channel. The method comprises activating, based on the indication, a third channel to the first wireless device that is different from the first channel.

It is an advantage of the present disclosure that the interference can be managed by activating the third channel which can include a Coverage Enhancing Device. In other words, the interference level experienced by the first wireless device can be independently defined and/or controlled by the network node so as to allow interference cancellation (such as successive interference cancellation) at the first wireless device. It may be appreciated that interference is increased to a level that enables interference decoding and application of successive interference cancelation. For example, by activating the third channel, interference cancellation at the first wireless device is enabled without the network node requiring complete channel state information.

The disclosed techniques are advantageous from a practical perspective, and are readily applicable to practical scenario, for example where a complete channel state information is not required.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising example network nodes, example wireless devices, and an example CED according to this disclosure,

FIG. 2 is a signalling diagram illustrating an example communication between network nodes, wireless devices, and a CED according to this disclosure,

FIG. 3 is a diagram illustrating an example interference decoding procedure at a wireless device according to this disclosure,

FIGS. 4A-4B are a flow-chart illustrating an example method, performed by a network node, for enabling mitigation of interference at a first wireless device according to this disclosure,

FIG. 5 is a flow-chart illustrating an example method, performed by a wireless device, for mitigating interference at a first wireless device according to this disclosure,

FIG. 6 is a block diagram illustrating an example network node according to this disclosure, and

FIG. 7 is a block diagram illustrating an example wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example need not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

A CED may suppress interference by steering signals towards specified directions. For example, signals redirected by the CED can be combined with other signals from other paths (such as direct paths, such as a path between a network node and an unintended wireless device) to mitigate interfering signals at a victim wireless device.

However, such approach may imply that the network node acquires instantaneous and accurate channel state information, CSI. Stated differently, it may be necessary to exchange CSI between the wireless device and the network node, which requires a considerable amount of signalling resources. Thus, such interference mitigation may come at the expense of a higher overhead.

The disclosed technique may allow mitigating interference at the first wireless device caused by a first signal intended for a second wireless device served by a network node, without such heavy overhead penalty of furnishing for instantaneous channel state information at the network node.

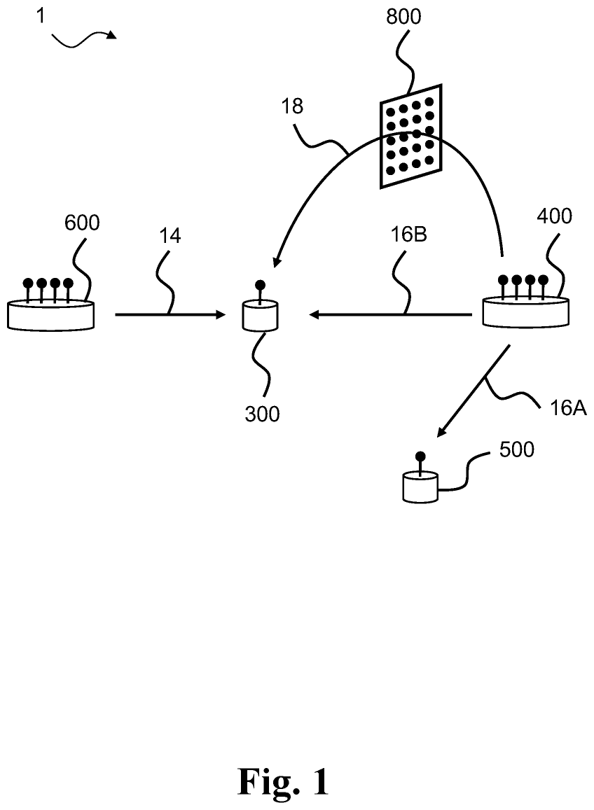

FIG. 1 is a diagram illustrating an example wireless communication system 1 comprising example network nodes 400, 600, example wireless devices 300, 500 and an example CED 800 according to this disclosure. In some examples, network node 400 is referred to as the first network node and network node 600 is referred to as the second network node.

As discussed in detail herein, the present disclosure relates to a wireless communication system 1 comprising a cellular system, for example, a 3GPP wireless communication system. The wireless communication system 1 comprises one or more of: one or more wireless devices 300, 500 and one or more network nodes 400, 600.

A network node disclosed herein refers to a radio access network, RAN, node operating in the radio access network, such as one or more of: a base station, BS, an evolved Node B, eNB, a gNB in NR, an access point, AP, and a small cell, SC. In one or more examples, the RAN node is a functional unit which may be distributed in several physical units.

A wireless device may refer to one or more of: a mobile device and a user equipment, UE.

The wireless device 300 may be configured to communicate with the network node 600 via a wireless link (or radio access link) 14. The wireless device 300 is for example part of a cell controlled by network node 600 (such as a small cell). In other words, the network node 600 serves the wireless device 300.

The wireless device 300 (also denoted first wireless device in the disclosure) may be in a situation where the communication with the network node 600 experiences interference from another network node, such as network node 400, which is as such not serving the wireless device 300.

The network node 400 may be configured to communicate with the wireless device 500 via a wireless link (or radio access link) 16A. The wireless link 16A can be used for a second channel disclosed herein. The wireless device 500 is for example part of a cell controlled by network node 400. In other words, the network node 400 serves the wireless device 500.

The communication between the network node 400 and the wireless device 500 (also denoted second wireless device in the disclosure) can cause interference to the wireless device 300.

The wireless device 300 may be configured to communicate with the network node 400 via a wireless link (or radio access link) 16B. The wireless link 16B can be used for a first channel disclosed herein.

The wireless communication system 1 may comprise one or more CEDs 800. The CED 800 may be configured to redirect signals between other components of the wireless communication system 1, such as the wireless devices 300, 500 and the network nodes 400, 600. In the example of FIG. 1, the network node 400 may be configured to communicate with the wireless device 300 via a wireless link (or radio access link) 18, in which the signals between the network node 400 and the first wireless device 300 are redirected by the CED 800. The wireless link 18 can be used for a third channel disclosed herein.

In some examples, the wireless device 300 may be denoted as a first wireless device which is served by the network node 600. In some examples, the wireless device 500 may be denoted as a second wireless device which is served by the network node 400. The network node 600 may be denoted as a second network node while the network node 400 may be denoted as first network node. The network nodes 400, 600 may be part of a same node.

Components of the disclosed CEDs, such as the active components and passive components, can be advantageous to redirect signals. As disclosed herein, redirecting can include one or more of: transmitting, reflecting, forwarding, scattering, regenerating, re-radiating, directing, retransmitting a signal, and allowing a signal to pass through. Redirecting, transmitting, and retransmitting may be used interchangeably. The redirecting may include altering direction, polarisation or both direction and polarisation of a signal. The redirecting may include one or more of: amplification, attenuation, termination, phase shifting, delaying and spatial manipulation of a signal. Spatial manipulation may be, for instance, splitting into multiple components, widening or in general applying any spatial filtering.

For example, the CEDs may redirect an incoming signal from a given incoming direction to a given outgoing direction. Components of the CEDs can be used to redirect signals in the mm-wave spectrum, in the sub-7 GHz spectrum, in the sub-6 GHz spectrum or in any other spectrum which may be used. Further, the components of the CEDs can be configured to make redirections of signals which appear in-phase in one or more of: a direction, an area, and a volume. The CED 800 may be configured by one or more of: the network nodes 400, 600 and the wireless devices 300, 500. In the embodiment of FIG. 1, the CED 800 may be configurable by the network node 400.

The CEDs can be used for network management. The coverage enhancing devices can be used for beam management, panel management or both beam management and panel management. The coverage enhancing devices can be used for far-field propagation, near-field propagation or both far-field propagation and near-field propagation. The coverage enhancing devices can utilize one or more of: passive array panels, active array panels and intelligent surfaces to improve coverage and beamforming of signals.

The disclosed CEDs can be one of a number of several types of devices, which can be used interchangeably herein. For example, the CEDs can be one or more of: reconfigurable intelligent surfaces, RISs, large intelligent surfaces, LISs, network configured repeaters, repeater nodes, repeater type devices, repeaters (such as, regenerative and/or non-regenerative), intelligent surfaces and reconfigurable reflective devices, RRDs. The CEDs can have one or more antennas, such as one or more of: antenna panels, antenna elements, antenna inputs, antenna outputs and unit cells for meta-surfaces. The CEDs can have one or more receivers, for example low-power receivers. The CEDs can have one or more transmitters, such as an active component that provides amplification to a signal.

In one or more example wireless communication systems, the signals disclosed herein can be one or more of: energy, wave energy, FR1 and FR2 signals, 5G signals, 6G signals, sub-6 GHZ, sub-THz, THz, electromagnetic energy, waves, electromagnetic plane waves, electromagnetic signals, plane signals, spherical waves, spherical signals, cylindrical waves, and cylindrical signals. As disclosed herein, waves and signals can be used interchangeably. Signals may include signals with any polarization properties. The particular type of signal is not limiting.

As disclosed herein, the terms signal, message and data can be used interchangeably. As used herein, the terms emitted, sent, and transmitted can be used interchangeably.

The network node 600 may transmit, to the wireless device 300, a second signal (such as, s₂(t) in Equation 1). The network node 400 may transmit, to the wireless device 500, a first signal (such as, s₁(t) in Equation 1). The wireless device 300 may experience interference from the network node 400 serving the wireless device 500. Communications from network node 400 may be seen as a source of interference for the wireless device 300.

In one or more examples, the wireless device 300 and the wireless device 500 may receive signals r₁(t) and r₂(t), respectively. Such signals (such as, in absence of noise) may be expressed as:

$${r}_{1} ( t ) = \sqrt{{P}_{2}} {s}_{2} ( t ) + \sqrt{{P}_{1}} {e}^{i {ϕ}_{α}} \sqrt{α} {s}_{1} ( t ) + \sqrt{{P}_{CED}} {e}^{i {ϕ}_{γ}} \sqrt{γ} {s}_{CED} ( t ) \qquad ( 1 )$$

$${r}_{2} ( t ) = \sqrt{{P}_{1}} {e}^{i {ϕ}_{β}} \sqrt{β} {s}_{1} ( t ) \qquad ( 2 )$$

where P₂ denotes a transmit power of the second signal s₂(t) sent from the network node 600 (so called second network node) towards the wireless device 300,
P₁ denotes a transmit power of the first signal s₁(t) sent from the network node 400 towards the wireless device 500,
P_{CED} denotes a transmit power of a signal s_{CED}(t) sent from the network node 400 towards the CED 800,
α denotes a propagation channel or path loss associated with a first channel, such as the channel between the network node 400 and the wireless device 300 relative to a reference propagation channel or path loss associated with a reference channel, such as the channel between the second network node 600 and the wireless device 300,
β denotes a propagation channel or path loss associated with a second channel, such as the channel between the network node 400 and the wireless device 500 relative to the reference propagation channel or path loss associated with the reference channel,
γ denotes a propagation channel or path loss associated with a third channel, such as the channel between the network node 400 and the wireless device 300 via the CED 800, relative to the reference propagation channel or path loss associated with the reference channel,
φ_{α} denotes a phase associated with the first channel relative to the reference channel,
φ_{β} denotes a phase associated with the second channel relative to the reference channel, and
φ_{γ} denotes a phase associated with the third channel relative to the reference channel.

In one or more examples, αP₁, βP₁, and γP_{CED} denote the first gain, the second gain, and the third gain respectively normalized based on the gain associated with the reference channel. In other words, the gain of the reference channel can take a reference value of “1” (such as, for normalization purposes). The gain (such as channel gain) may be seen as the transmit power applied and affected by the propagation loss on the channel.

In one or more examples, the network node 400 determines the first gain, the second gain and the third gain jointly, for example, by following relations disclosed herein, as illustrated in Equation 9.

In one or more examples, the wireless device 300 may receive, from the second network node 600, a second signal (such as, \sqrt{P₂}s₂(t) of Equation 1).

The network node 400 can transmit, to the wireless device 300, the first signal using the first gain (for example in the form of: \sqrt{P₁}e^{iφα}\sqrt{α}s₁(t) of Equation 1). The network node 400 can transmit to the wireless device 300 via the CED 800, the first signal using the third gain (such as, in the form of: \sqrt{P_{CED}}e^{iφγ}\sqrt{γ}s_{CED}(t) of Equation 1).

In one or more examples, r₁(t) may be seen as an aggregate signal (such as, superimposed signal) comprising the first signals and the second signal.

In one or more examples, the network node 400 transmits a same signal across the CED 800 as the one sent towards the wireless device 500, such as s_{CED}(t)=s₁(t).

A reasonable approximation for signal r₁(t) may be expressed as,

$${r}_{1} ( t ) \approx \sqrt{{P}_{2}} {s}_{2} ( t ) + \sqrt{γ {P}_{CED} + α {P}_{1}} {e}^{i ϕ} {s}_{1} ( t ) + {n}_{2} ( t ) \qquad ( 3 )$$

Such approximation may indicate that two signals with amplitudes A and B, but with random phases, have a deterministic amplitude of \sqrt{A²+B²}. Such amplitude may be an average amplitude. For example, the approximation includes replacing an instantaneous amplitude with an average amplitude.

The wireless devices 300, 500 may be associated with spectral efficiencies ρ₂, and ρ₁ respectively. For example, assuming that spectral efficiencies ρ₁ and ρ₂ are desired to the wireless devices 500, 300 without activating the CED, respectively, and defining \tilde{ρ}ₖ=2^{ρk}−1. To satisfy ρ₁, the transmit powers P₁, P₂ may be, at least,

$${P}_{2} = N {\tilde{ρ}}_{2} ( 1 + \frac{α {\tilde{ρ}}_{1}}{β} ) \qquad ( 4 )$$

$${P}_{1} = N \frac{{\tilde{ρ}}_{1}}{β} \qquad ( 5 )$$

where N denotes a total noise power at the wireless devices 300, 500. The total noise power N may be the same for both wireless devices 300, 500. Equations 4 and 5 may follow from the Shannon's capacity formula.

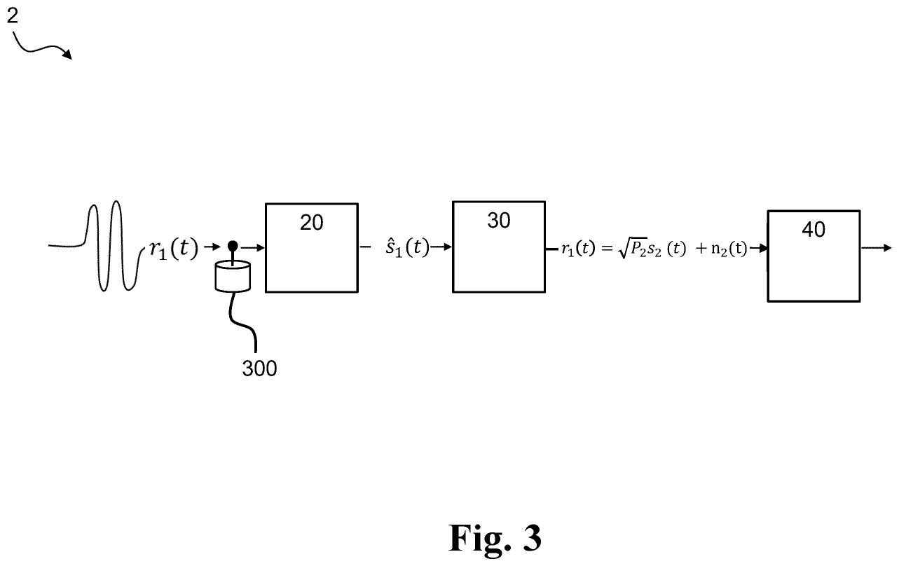

Using a CED and relying on interference cancellation (such as, as illustrated in FIG. 3) at the wireless device 500, the transmit powers P₁, P₂, P_{CED} may be expressed as,

$${P}_{2} = N {\tilde{ρ}}_{2} \qquad ( 6 )$$

$${P}_{1} = N \frac{{\tilde{ρ}}_{1}}{β} \qquad ( 7 )$$

$${P}_{CED} = \frac{N}{γ} {\tilde{ρ}}_{1} ( {\tilde{ρ}}_{2} + 1 - \frac{α}{β} ) \qquad ( 8 )$$

Let P_{Σ,bsl} denote P₁+P₂, such as a sum power of the system for the baseline (such as, a total transmitting power of the system when the CED 800 is not used for interference mitigation). Let P_{Σ,CED} denote P₁+P₂+P_{CED}, such as a sum power of the system (such as, a total transmitting power) when the CED 800 for interference mitigation. The overall gain (such as a fourth gain disclosed herein) of using the CED 800 for interference mitigation at the wireless device 300 may be expressed as,

$$Δ = {P}_{\sum , bs 1} - {P}_{\sum , CED} = \frac{N}{γ} {\tilde{ρ}}_{1} ( {\tilde{ρ}}_{2} ( \frac{γ α}{β} - 1 ) + \frac{α}{β} - 1 ) \qquad ( 9 )$$

The present disclosure may be particularly beneficial for parameter combinations of (α, β, γ) yielding Δ>0, such as when the CED 800 is activated to transmit and/or redirect a signal (such as, s_{CED}(t)=s₁(t)) from the network node 400 to the wireless device 300. In other words, Equation 9 may be seen as characterizing the relation between the first gain, the second gain and the third gain. For example, for γ<1 and Δ>0, it is required that α>β, as illustrated in Equation (9). α>β may indicate that the interference (such as, \sqrt{P₁}e^{iφ}_{α}\sqrt{α}s₁(t)) experienced by the wireless device 300 over the first channel (such as, an interference link) is stronger than a signal (such as, \sqrt{P₁}e^{iφ}_{β}\sqrt{β}s₁(t), such as r₂(t)) received by the wireless device 500 over the second channel (such as, a data link). In other words, such parameter combination may indicate that the wireless device 300 experiences a strong interference which is caused by the wireless device 500, with the wireless device 500 being served by the network node 400. The present disclosure provides, inter alia, a joint determination and/or a joint configuration of the first gain, the second gain and the third gain.

For example, the gain Δ is indicative of a benefit of using the CED 800 for suppressing interference at the wireless device 300 compared to an increase of the gain αP₁.

For example, the gain Δ is associated with a transmit power of a signal (such as, s_{CED}(t)=s₁(t)) to be redirected by the CED 800 when using (such as, activating) the CED 800 for suppressing interference at the wireless device 300. The CED 800 may enable interference mitigation at the wireless device 300 by redirecting a signal associated with a higher transmit power P_{CED} from the network node 400 to the wireless device 300. An increased transmit power P_{CED} may result in an increased gain γP_{CED}. In other words, a stronger channel between the network node 400 to the wireless device 300 via the CED 500 may be generated based on the increased gain γP_{CED}. In other words, the gain Δ can be seen as how much transmit power should be assigned to the CED 800 for redirecting the signal s_{CED}(t), such as signal s₁(t).

For example, the gain Δ may increase with growing values of \tilde{ρ}₁. The gain Δ may be based on spectral efficiency \tilde{ρ}₁ of the wireless device 500 and on spectral efficiency \tilde{ρ}₂ of the wireless device 300. In this particular embodiment, the wireless device 500 may have a higher spectral efficiency \tilde{ρ}₁ (such as, a higher data rate) than the spectral efficiency \tilde{ρ}₂ of the wireless device 300 which suffers from strong interference caused by the wireless device 500 (such as, as illustrated by α>β). The present disclosure may be advantageous for cases where a wireless device requires an increased in spectral efficiency (such as, an increased throughput and/or data rate) while communicating with a node (such as, a network node) through a channel with poor quality. It may be beneficial to use the CED 800 for interference mitigation at the wireless device 300 for enabling the wireless device 300 to have a higher spectral efficiency ρ₁.

For example, the present disclosure can be advantageous for parameter combinations (α, β, γ) (such as, parameter regimes) where Δ>0, γ<1, and α>β. The present disclosure may allow balancing the gains αP₁, βP₁, γP_{CED} based on a condition of a wireless device, such as a wireless device experiencing a severe outage. Balancing the gains αP₁, βP₁, γP_{CED} may comprise determining a transmit power towards the CED 800, the wireless device 300 and the wireless device 500.

This demonstration illustrates an example of a parameter (α, β, γ) regime in which the present disclosure may be applicable. The present disclosure may be applicable to other parameter combinations (α, β, γ) and other spectral efficiencies (such as, not necessarily higher spectral efficiencies).

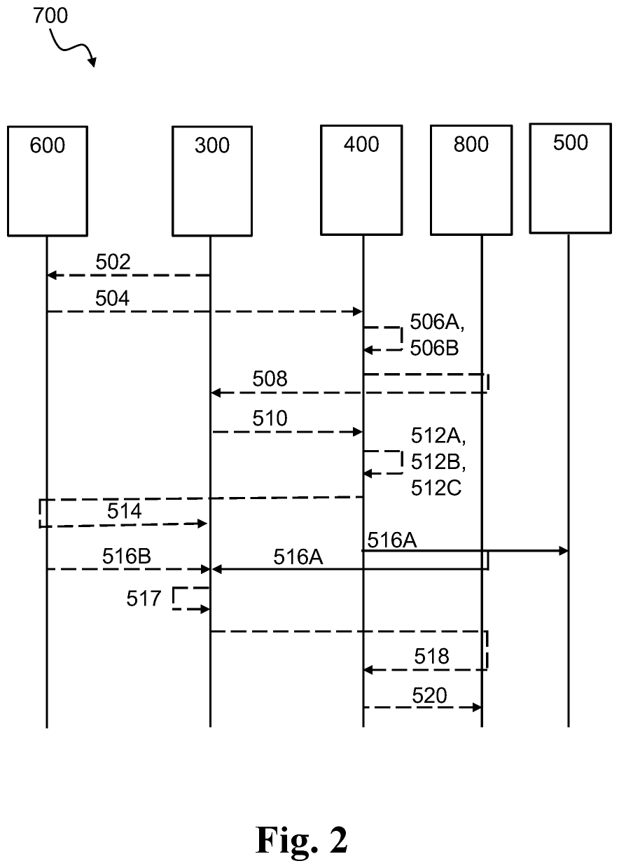

FIG. 2 is a signalling diagram illustrating an example communication 700 between network nodes 400, 600, wireless devices 300, 500, and a CED 800 according to this disclosure.

The wireless device 300 may be denoted as a first wireless device which is served by the network node 600. The wireless device 500 may be denoted as a second wireless device which is served by the network node 400. The network node 600 may be a second network node.

The network node 600 is configured to transmit, to the wireless device 300, a second signal (such as, signal s₂(t) of Equation 1). The network node 400 is configured to transmit, to the wireless device 500, a first signal (such as, signal s₁(t) of Equation 1). The wireless device 300 may experience interference from the network node 400 serving the wireless device 500. In other words, a received signal at the wireless device 300 may include a first component associated with the second signal and a second component associated with the first signal. The network node 400 may be seen as a source of interference for the wireless device 300.

In one or more examples, the wireless device 300 transmits, to the network node 600, an indication 502 indicating that the wireless device 300 is experiencing interference from the network node 400 serving the wireless device 500. The wireless device 300 may be capable of detecting inter-cell interference, ICI. Put differently, the wireless device 300 may be configured to report, to the network node 600, strong interference from the network node 400.

In one or more examples, the network node 600 is configured to transmit, to the network node 400, control signalling 504 indicative of an interference level associated with the wireless device 300, such as an interference caused by the first signal intended for the wireless device 500 which is served by the network node 400.

In one or more examples, the network node 400 is configured to determine, based on the control signalling 504, that the interference experienced by the wireless device 300 over a first channel (such as, a channel between the network node 400 and the wireless device 300) is stronger than the first signal received by the wireless device 500 over the second channel (such as, a channel between the network node 400 and the wireless device 500). Stated differently, the network node 400 may determine that a first gain 506A is greater than the second gain 506B. The first gain 506A may be associated with the first channel, such as αP₁. The second gain 506B may be associated with the second channel, such as βP₁. The network node 400 may determine that αP₁>βP₁.

Determining that αP₁>βP₁ may include determining that the wireless device 300 experiences a strong interference caused by the wireless device 500, which is served by the network node 400. In other words, the wireless device 300 may be in severe outage due to ICI. The wireless device may be seen as a wireless device at cell-edge. The ICI may impact the spectral efficiency of the wireless device 300 (such as, \tilde{ρ}₂ of Equations 4, 6, 8, and 9).

In one or more examples, the network node 400 is configured to activate (such as, configure) a third channel 508, such as a channel between the network node 400 and the wireless device 300 via the CED 800. In other words, the network node 400 may probe the third channel to the wireless device 300 via the CED 800. Establishing 508 the third channel may involve communication between the network node 400 and the network node 600 for resource allocation.

In one or more examples, the wireless device 300 is configured to transmit, to the network node 400, a third gain 510. The third gain 510 may be associated with the third channel, such as γP_{CED}. Optionally, the wireless device 300 is configured to transmit the third gain 510 to the network node 400 via the network node 600.

In one or more examples, the network node 400 is configured to determine, based on the first gain 506A, the second gain 506B, and the third gain 510, a fourth gain 512A. The fourth gain 512A may be seen as the benefit of using the CED 800 for interference mitigation at the wireless device 300, such as Δ. The network node 400 may determine the fourth parameter based on Equation 9.

In one or more examples, the network node 400 is configured to determine, based on the fourth gain 512A, an interference mitigation technique to be applied at the wireless device 300 for decoding the received signal (such as, for provision signal s₂(t)).

In one or more examples, the network node 400 is configured to determine that the fourth gain 512A is greater than or equal to a threshold (such as, Δ>0). In other words, the interference experienced by the wireless device 300 over the first channel is deemed stronger (such as greater) than the first signal received by a second wireless device (such as wireless device 500 of FIG. 1) served by the network node 400. Determining that the fourth gain 512A is greater than the threshold may comprise activating the CED for enabling interference mitigation at the wireless device 300. The CED 800 may mitigate interference at the wireless device 300 by redirecting the first signal associated with a higher transmit power P_{CED} from the network node 400 to the wireless device 300. The CED 800 may be configured to mitigate interference at the wireless device 300 by redirecting the first signal associated with a higher transmit power P_{CED} from the network node 400 to the wireless device 300, such as by increasing the third gain 510. Upon determining that the fourth gain 512A is greater than a threshold, the network node 400 may select an interference decoding procedure 512B (such as, interference decoding procedure 2 of FIG. 2) for mitigating interference caused by the first signal at the wireless device 300.

In one or more examples, the network node 400 is configured to determine that the fourth gain 512A is less than or equal to the threshold (such as, Δ≤0). Determining that the fourth gain 512A is less than or equal to the threshold may comprise not using the CED for redirecting first signal associated with a higher transmit power P_{CED} from the network node 400 to the wireless device 300. Upon determining that the fourth gain 512A is less than or equal to a threshold, the network node 400 selects an interference mitigation procedure 512C different from the interference decoding procedure 512B, such as an interference mitigation procedure 512C based on resource scheduling.

In one or more examples, the network node 400 is configured to transmit, to wireless device 300 via the network node 600 serving the first wireless device, decoding configuration data 514. The decoding configuration data 514 may include information necessary to decode the received signal. For example, the decoding configuration data 514 comprises one or more of: the selected interference decoding procedure, an allocated resource, a modulation-and-coding scheme, and redundancy version.

Optionally, the network node 400 may transmit, to the network node 600, the first gain 506A, the second gain 506B, and the third gain 510. The network node 600 may determine, based on the first gain 506A, the second gain 506B, and the third gain 510, the fourth gain 512A. The network node 600 may determine, based on the fourth gain 512A, the interference mitigation technique to be applied at the wireless device 300 for decoding the received signal. The network node 600 may transmit, to the network node 600, the decoding configuration data 514.

In one or more examples, the network node 400 is configured to transmit, to the wireless device 300 directly and via the CED 800, the first signal 516A (such as, signal s₁(t) of Equation 1, with s_{CED}(t)=s₁(t)). In one or more examples, the network node 400 is configured to transmit, to the wireless device 500 (such as, a second wireless device), the first signal 516A. In one or more examples, the first signal 516A is transmitted from the network node 400 to wireless device 500 and to wireless device 300 directly and via the CED 800, for example over the same time and/or frequency resources (such as at the same transmission time and/or simultaneously). In one or more examples, the network node 600 is configured to transmit, to the wireless device 300, the second signal 516B (such as, signal s₂(t) of Equation 1). The first signal 516A, and the second signal 516B may be transmitted by the network node 400 (such as, to the wireless devices 300, 500) and the network node 600 (such as, to the wireless device 300), respectively, in a same time period and/or in a same set of frequency resources. In other words, the transmission of the first signal 516A and the second signal 516B may be simultaneous data transmissions. The received signal at the wireless device 300, when activating the CED 800 for interference mitigation at the wireless device 300, may be seen as a superimposition of the first signal 516A and the second signal 516B (such as, expressed by signal r₁(t) of Equation 1.)

In one or more examples, the wireless device performs interference decoding 517 on the received signal by applying the interference decoding procedure 512B to the received signal. In one or more examples, the wireless device 300 is capable of decoding the received signal when the CED 800 redirects the second signal, in which the second signal being is associated with a higher transmit power P_{CED}. An increased transmit power P_{CED} may result in an increased gain γP_{CED}.

In one or more examples, the wireless device 300 is configured to transmit, to the network node 400, feedback 518 indicative of a success or a failure of the interference decoding procedure 512B. The wireless device 300 may transmit the feedback 518 directly to the network node 400, and/or via the CED 800 and/or via the network node 600 (so called second network node). In one or more examples, the wireless device can inform the network node 400 on the success of the interference decoding procedure 512B by transmitting an acknowledgment, ACK. In one or more examples, the wireless device can inform the network node 400 on failure of the interference decoding procedure 512B by transmitting a negative acknowledgment, NACK.

In one or more examples, the network node 400 is configured to adjust, based on the feedback 518, the third gain 510 for provision of an adjusted third gain 520.

The present disclosure may provide control signalling, such as the decoding configuration data 514, to be communicated between the wireless device 400 and the wireless device 600 for adjusting the CED 800. The present disclosure may not require resource scheduling for interference mitigation at the wireless device 300.

In one or more examples, the network node 400 configures the CED 800 when receiving, from the wireless device 300, that the feedback 518 indicates a failure of the interference decoding procedure 512B. The network node 400 may configure the CED 800 by selecting a beam pattern associated with the CED 800 for enabling the interference decoding at the wireless device 300. The network node 400 may configure the CED 800 by increasing the third gain 510 (such as, γP_{CED}). The network node 400 may configure the CED 800 by increasing a transmit power P_{CED} of a signal s_{CED}(t) (such as, s_{CED}(t)=s₁(t)) sent from the network node 400 towards the CED 800. Put differently, the network node 400 may configure the CED 800 by increasing the transmit power of the first signal 516A when the first signal 516A is redirected by the CED 800.

In one or more examples, the network node 400 is configured to decrease the third gain 510 when receiving, from the wireless device 300, that the feedback 518 indicates a success of the interference decoding procedure 512B. The network node 400 may decrease the third gain 510 for improving power consumption (such as, saving energy). The network node 400 may decrease the third gain 510 for reducing a risk of interference to other nodes of a wireless communication system where the disclosed technique is applied.

In one or more examples, the wireless device 300 can transmit, to the network node 400, further feedback after the adjustment of the third gain 510. Such further feedback may result in further adjustments of the adjusted third gain 520.

The present disclosure provides an iterative technique for interference mitigation via a CED. Such iterative technique may be particularly advantageous when the network node 400 acquires incomplete channel state information, CSI, on the first channel (such as, the channel between the network node 400 and the wireless device 300) and/or on the third channel (such as, the channel between the network node 400 and the wireless device 300 via the CED 800).

FIG. 3 is a diagram illustrating an example interference decoding procedure 2 at a wireless device, such as wireless device 300, according to this disclosure.

In one or more examples, the wireless device 300 is configured to perform a first decoding procedure 20 on signal r₁(t). In other words, the wireless device 300 may decode r₁(t) for provision of a decoded signal s₁(t) (such as, a reconstructed signal associated with signal s₁(t)). The signal s₁(t) may be decoded from r₁(t) by performing interference decoding (such as treating s_{CED}(t) as assisting the decoding process).

In one or more examples, upon decoding signal s₁(t), the wireless device 300 is configured to perform, based on the decoded signal s₁(t), interference cancellation 30 on signal r₁(t). In other words, the wireless device 300 may subtract the decoded interfering signal ŝ₁(t) from signal r₁(t) for provision of a signal \tilde{r}₁(t) (such as, \tilde{r}₁(t)=r₁(t)−\sqrt{P₁}e^{iφ}_{α}\sqrt{α}ŝ₁(t)). For example, since signal \tilde{r}₁ does not comprise any interfering component (such as, the first signal s₁(t)), the second signal s₂(t) can be decoded by the wireless device 300. In other words, \tilde{r} can be seen as an interference free signal in that the signal is free from the interference caused by the first signal.

In one or more examples, upon performing interference cancellation, the wireless device 300 is configured to perform a second decoding procedure 40 on signal \tilde{r}₁(t). Put differently, the wireless device 300 may decode second signal s₂(t) from signal \tilde{r}₁(t), such as without interference caused by first signal s₁(t). For example, the obtained signal may be expressed as:

$${r}_{1} ( t ) = \sqrt{{P}_{2}} {s}_{2} ( t ) + {n}_{2} ( t ) \qquad ( 10 )$$

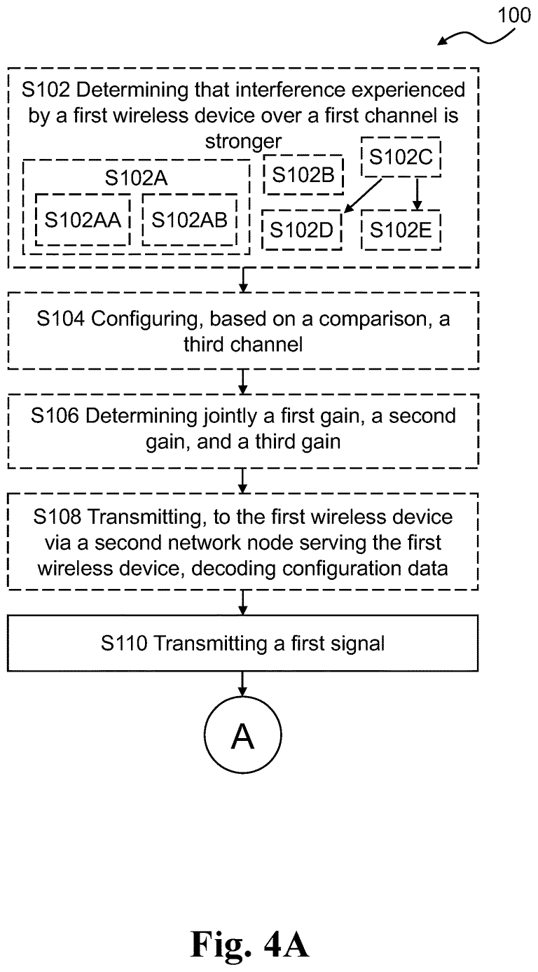

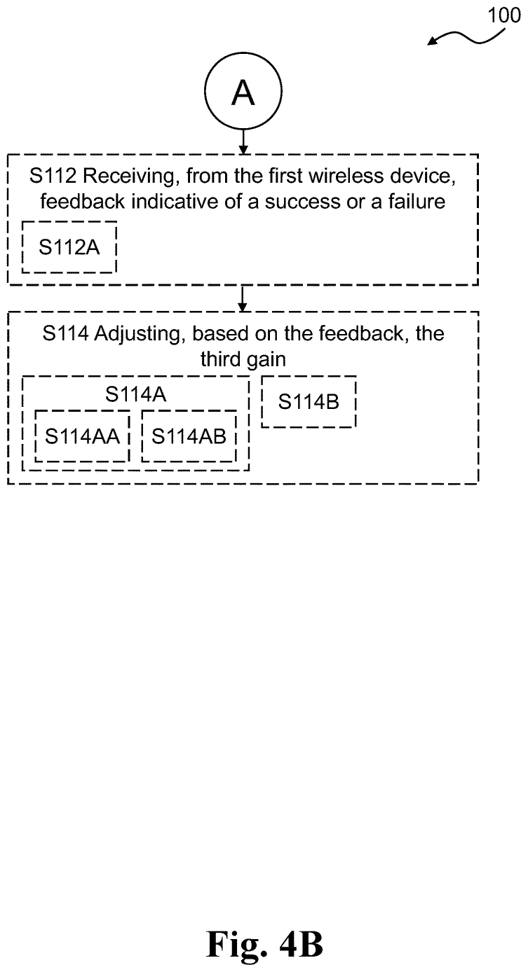

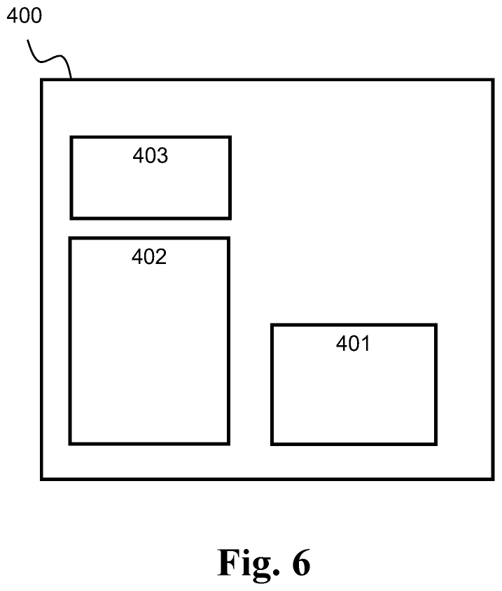

FIGS. 4A-4B show a flow-chart of an example method 100, performed by a network node, for enabling mitigation of interference at a first wireless device (such as, wireless device 300 of FIGS. 1, 2, 3 and 7). The interference is caused by a first signal (such as, signal s₁(t) of Equations 1, 2 and 3) intended for a second wireless device (such as, wireless device 500 of FIGS. 1, 2, and 3) served by the network node. The network node is the network node disclosed herein, such as network node 400 of FIG. 1, FIG. 2, and FIG. 6. The network node carrying out method 100 may be denoted as first network node. The first wireless device is not served by the network node (also called first network node, network node 400 of FIGS. 1 and 2) but is served by a second network node (such as network node 600 of FIGS. 1 and 2). The first wireless device can be seen a wireless device victim of interference caused by communications in a cell controlled by the network node, such as a neighbouring cell.

The method 100 comprises transmitting S110 the first signal to the first wireless device, using a first gain (such as, first gain αP₁) associated with a first channel between the network node and the first wireless device (such as, wireless link 16B of FIG. 1). The method 100 comprises transmitting S110 the first signal to the first wireless device, via a coverage enhancing device, CED (such as, CED 800 of FIGS. 1 and 2), using a third gain (such as, third gain γP_{CED}) associated with a third channel (such as, wireless link 18 of FIG. 1) between the network node and the first wireless device via the CED. The method 100 comprises transmitting S110 the first signal to the second wireless device, using a second gain (such as, second gain βP₁) associated with a second channel (such as, wireless link 16A of FIG. 1) between the network node and the second wireless device. In other words, for example, the first signal is transmitted by the network node to the first wireless device via the first channel and the third channel by applying the first gain and the third gain respectively. In some examples, the first signal is also transmitted by the network node to the second wireless device via a second channel and using the second gain. In one or more examples, the network node is configured to transmit the first signal to the first wireless device and the second wireless device (such as, to one or more wireless devices) via respective channels and respective gains. In other words, for example, the first signal is transmitted by the network node to the first wireless device via the first channel and the third channel by applying the first gain and the third gain respectively, and to the second wireless device via the second channel by applying the second gain. Stated differently, the first signal is transmitted by the network node to the first wireless device via the first channel, the second channel, and the third channel in the same time resource and/or the same frequency resource (for example at the same time and/or simultaneously).

The first signal may be seen as a signal intended to the second wireless device but configured to enable interference decoding at the first wireless device. In one or more example methods, the first signal is intended for enabling interference decoding at the first wireless device and includes data intended for the second wireless device. In one or more examples, the interference is caused by the first signal comprising data intended for the second wireless device served by the network node.

In one or more example methods, the method 100 comprises determining S106 jointly the first gain, the second gain, and the third gain. The first gain, the second gain, and the third gain may be jointly determined, for example for use in the interference mitigation. In one or more examples, the first gain, the second gain, and the third gain are determined, such as in relation to one another. In one or more examples, the first gain, the second gain, and the third gain are mutually related, in that the first gain and/or the third gain are determined based on the second gain. In other words, for example, the first gain, the second gain and the third gain are determined so that interference decoding can be achieved by the first wireless device as illustrated in FIGS. 1 and 3. Stated differently, the first gain and third gain can be determined as a function of the second gain, and optionally of target spectral efficiencies as discussed in FIG. 1, such as in Equations 6, 7, and/or 8. In one or more examples, a gain (such as the first gain, the second gain, and the third gain) is determined by adjusting a transmit power (such as, P₁, P_{CED}) of the first signal to be transmitted on the respective channel (such as first channel, second channel and third channel). The first gain may be associated with a propagation path loss (such as, α) associated with the first channel. The second gain may be associated with a propagation path loss (such as, β) associated with the second channel. In one or more examples, determining the third gain jointly with the other gains includes determining a transmit power (such as, P_{CED}) of a signal transmitted from the network node to the CED (such as, s_{CED}(t) of Equation 1). For example, the signal transmitted from the network node to the CED is the first signal (such as, s_{CED}(t)=s₁(t)). The first signal may be transmitted, from the network node, and redirected (such as, reflected) by the CED to the first wireless device. The third gain may be associated with a propagation path loss (such as, γ) associated with the third channel. In some examples, the propagation path losses may be tunable by changing the configuration of the CED to direct more or less energy to the first wireless device, and/or by tuning the gain of the CED (for example when the CED is an active CED with a tunable gain).

In one or more examples, determining jointly the first gain, the second gain, and the third gain comprises determining a transmit power towards the first wireless device directly and via the CED, and towards the second wireless device. In other words, determining jointly the first gain, the second gain, and the third gain may comprise performing a power balancing between a transmit power (such as P_{CED}) for the third channel, a transmit power (such as P₁) for the first channel in relation to a transmit power for the second channel (such as P₂). In other words, the first gain, the second gain, and the third gain are configured together for the transmission of the first signal to achieve an intended communication with the second wireless device while enable interference decoding at the first wireless device victim of the interference.

In one or more example methods, the method comprises transmitting control signalling and/or an indication to the first wireless device that the first wireless device is to apply interference decoding procedure. In one or more examples, an indication to the first wireless device to attempt and/or to apply interference decoding (to the interfering signals from the network node) may be taken as an indication that the network node has jointly determined the first, second, and third gains according to the disclosed technique, for example as illustrated in Equation 4, 5, 6, 7, 8, and/or 9.

In one or more example methods, determining S106, jointly, a first gain, a second gain, and a third gain comprises using, as a reference value, a gain of a channel between the first wireless device and a second network node serving the first wireless device (such as, reference value of “1”). In one or more example methods, the channel between the first wireless device and the second network node is used to communicate a second signal in a same time period and a same set of frequency resources as the first signal is communicated (such as, the first signal and the second signal are at least partially overlapped). In one or more examples, the received signal at the first wireless device is based on the first signal and the second signal. The received signal at the first wireless device may be seen as a superimposed signal. In one or more examples, the second network node and the network node share a same frequency band at a same time.

In one or more example methods, the method comprises receiving S112, from the first wireless device, feedback indicative of a success or a failure of an interference decoding procedure for mitigating interference caused by the first signal (such as, feedback 518 of FIG. 2). In one or more examples, the wireless device can inform the network node 400 on the success of the interference decoding procedure by transmitting an acknowledgment, ACK. In one or more examples, the wireless device can inform the network node 400 on failure of the interference decoding procedure by transmitting a negative acknowledgment, NACK. In one or more example methods, receiving S112 the feedback (such as, feedback 518 of FIG. 2) comprises receiving S112A the feedback via the CED and/or the second network node.

In one or more example methods, the method comprises adjusting S114, based on the feedback, the third gain (such as, for provision of adjusted third gain 520 of FIG. 2). In one or more examples, adjusting the third gain may comprise adjusting the transmit power (such as, P_{CED}) of the signal (such as, s_{CED}(t) of Equation 1, with s_{CED}(t)=s₁(t)) transmitted from the network node via the CED to the first wireless device. In other words, adjusting the third gain may include adjusting an interfering power towards the first wireless device as the first signal is intended for the second wireless device.

In one or more example methods, adjusting S114 the third gain comprises configuring (such as, controlling) S114A the CED upon receiving that the feedback indicates a failure of the interference decoding procedure. In one or more examples, the first wireless device has not been able to perform the interference decoding by applying the interference decoding procedure to the received signal from the network node (such as, r₁(t) of Equations 1 and 3).

In one or more example methods, configuring S114A the CED comprises selecting S114AA a beam pattern associated with the CED for enabling the interference decoding at the first wireless device. In one or more examples, the network node controls the CED to search for the first wireless device by performing beam sweeping. For example, the network node transmits the first signal using two beams (such as, one beam towards the second wireless device and another beam towards the CED). By selecting the beam pattern associated with the CED, the CED may be configured to communicate with the first wireless device (such as, to reflect the first signal towards the first wireless device.

In one or more example methods, configuring S114A the CED comprises increasing S114AB the third gain (such as, third gain 510 of FIG. 2, such as γP_{CED}). In other words, the network node may be configured to increase the transmit power of the signal to be redirected by the CED (such as, s_{CED}(t) of Equation 1, with s_{CED}(t)=s₁(t)), such as the first signal to the first wireless device. Overall, the interference level experienced by the first wireless device may be higher than without applying the disclosed technique so that the first wireless device can successfully perform interference decoding and cancellation (such as successive interference cancellation).

In one or more example methods, adjusting S114 the third gain comprises decreasing S114B the third gain (such as, third gain 510 of FIG. 2, such as γP_{CED}) upon receiving that the feedback indicates a success of the interference decoding procedure. In one or more examples, the first wireless device has been able to perform the interference decoding by applying the interference decoding procedure to the received signal from the network node (such as, r₁(t) of Equations 1 and 3). In one or more examples, the network node may be configured to decrease the transmit power of the signal to be redirected by the CED (such as, s_{CED}(t) of Equation 1, with s_{CED}(t)=s₁(t)), such as the first signal. In one or more examples, the network node may decrease the third gain for improving power consumption (such as, saving energy).

In one or more example methods, the method 100 comprises determining S102 that interference experienced by the first wireless device over the first channel is stronger than the first signal received by the second wireless device over the second channel. In one or more examples, the network node is configured to receive, from the first wireless device (such as, via a network node serving the first wireless device), control signalling indicative of interference reports. The network node may determine, based on the control signalling, that the interference experienced by the first wireless device over the first channel is stronger than the first signal received by the second wireless device over the second channel.

Optionally, the network node (such as first network node, such as network node 400 of FIGS. 1 and 2) is configured to receive, from the network node serving the first wireless device (such as, a second network node, such as network node 600 of FIG. 2), control signalling (such as, control signalling 504 of FIG. 2) indicative of an interference level associated with the first wireless device. The network node serving the first wireless device may receive, from the first wireless device, an indication (such as, indication 502 of FIG. 2) that the first wireless device is experiencing interference from the network node serving the second wireless device. The network node serving the first wireless device may transmit, to the network node, the control signalling based on the indication.

In one or more examples, the control signalling indicative of an interference level associated with the first wireless device can be in form of a flag and/or one or more control messages. For example, the flag may be seen as an implicit signalling indicating to the network node an interference level associated with the first wireless device. For example, the one or more control messages can indicate to the network node an interference level associated with the first wireless device. For example, the one or more control messages can include information indicating to the network node an interference level associated with the first wireless device.

In one or more example methods, determining S102 comprises comparing S102A the first gain with the second gain. In one or more examples, comparing the first gain (such as, first gain 506A of FIG. 2) with the second gain (such as, second gain 506B of FIG. 2) comprises comparing αP₁ with βP₁. In other words, the network node may be configured to compare a gain associated with the first channel with a gain associated with the second channel.

In one or more example methods, comparing S102A the first gain with the second gain comprises determining S102AA whether the comparison meets a first criterion. In one or more example methods, comparing S102A the first gain with the second gain comprises, upon the comparison meeting the first criterion, determining S102AB that the interference experienced by the first wireless device over the first channel is stronger than the first signal received by the second wireless device over the second channel. In one or more examples, the comparison meets the first criterion when the first gain is greater than the second gain. In other words, the network node may determine that αP₁>βP₁ as illustrated in FIG. 1. In one or more examples, determining that the interference experienced by the first wireless device over the first channel is stronger than the first signal received by the second wireless device over the second channel includes determining that the first wireless device experiences a strong interference caused by the second wireless device, which is served by the network node. The first wireless device may be in severe outage, having low spectral efficiency.

In one or more examples, the comparison does not meet the first criterion when the first gain is less than or equal to the second gain. In other words, for example, the comparison does not meet the first criterion when the network node determines that αP₁≤βP₁. Determining that the first gain less than or equal to the second gain may comprise foregoing the transmission of the first signal to the first wireless device and the transmission of the second signal to the second wireless device (such as, S110).

In one or more example methods, determining S102 that interference experienced by the first wireless device over the first channel is stronger than the first signal received by the second wireless device over the second channel comprises determining S102B, based on the first gain, the second gain, and the third gain, a fourth gain (such as, gain Δ of Equation 9) associated with a spectral efficiency of the first wireless device (such as, P₁) and a spectral efficiency of the second wireless device (such as, P₂). In one or more examples, the fourth gain (such as, fourth gain 512A of FIG. 2) may be determined based on Equation 9. The fourth gain in transmit power may be seen as a gain of activating the CED vs. not activating the CED. For example, the fourth gain may be expressed by Equation 9. For example, the fourth gain is the sum of the transmit powers at both network nodes (such as the network node 400 and the second network node 600 of FIG. 1) compared with the sum of the transmit powers when the CED is not activated.

In one or more example methods, determining S102 comprises determining S102C whether the fourth gain meets a second criterion. In one or more examples, the network node determines, based on the fourth gain, an interference mitigation technique to be applied at the first wireless device for decoding the received signal.

In one or more example methods, determining S102 comprises, upon determining that fourth gain meets the second criterion, selecting S102D the interference decoding procedure (such as, interference decoding procedure 512B of FIG. 2). In one or more examples, the fourth gain meets the second criterion when the fourth gain is greater than zero (such as, when Δ>0). In one or more examples, having the fourth gain greater than zero results in that it may be beneficial for the wireless communication system where the disclosed technique is applied to activate the CED for transmitting and/or redirecting the first signal from the network node 400 to the wireless device 300. In one or more examples, activating the CED for interference mitigation at the first wireless device may comprise adjusting (such as increasing) the third gain (such as, γP_{CED}). The first wireless device may be capable of decoding the received signal by applying the interference decoding procedure to the received signal when the third channel is associated with an increased third gain. In one or more examples, the network node selects the interference decoding procedure to be applied at the first wireless device for interference mitigation.

In one or more example methods, determining S102 comprises, upon determining that fourth gain does not meet the second criterion, selecting S102E an interference mitigation procedure (such as, interference mitigation procedure 512C of FIG. 2) different from the interference decoding procedure. In one or more examples, the fourth gain does not meet the second criterion when the fourth gain is less than or equal to zero (such as, when Δ≤0). In one or more examples, it is not required to activate the CED for enabling interference mitigation at the first wireless device.

In one or more example methods, the method 100 comprises configuring S104, based on the comparison, the third channel. In one or more examples, the network node may be configured to activate (such as, to establish) the third channel. In one or more examples, the network node serves the second wireless device. The network node may activate the third channel for communicating with the first wireless device that is served by the second network node (such as, network node 600 of FIGS. 1 and 2). In one or more examples, activating the third channel comprises scheduling resources for performing interference management towards the first wireless device.

In one or more example methods, the method 100 comprises transmitting S108, to the first wireless device via a second network node serving the first wireless device, decoding configuration data (such as, decoding configuration data 514 of FIG. 2 via second network node 600). In one or more example methods, the decoding configuration data comprises one or more of: the selected interference decoding procedure, an allocated resource, a modulation-and-coding scheme, and redundancy version.

In one or more example methods, the network node (such as, network node 400) and a second network node serving the first wireless device (such as, network node 600) are part of a same node.

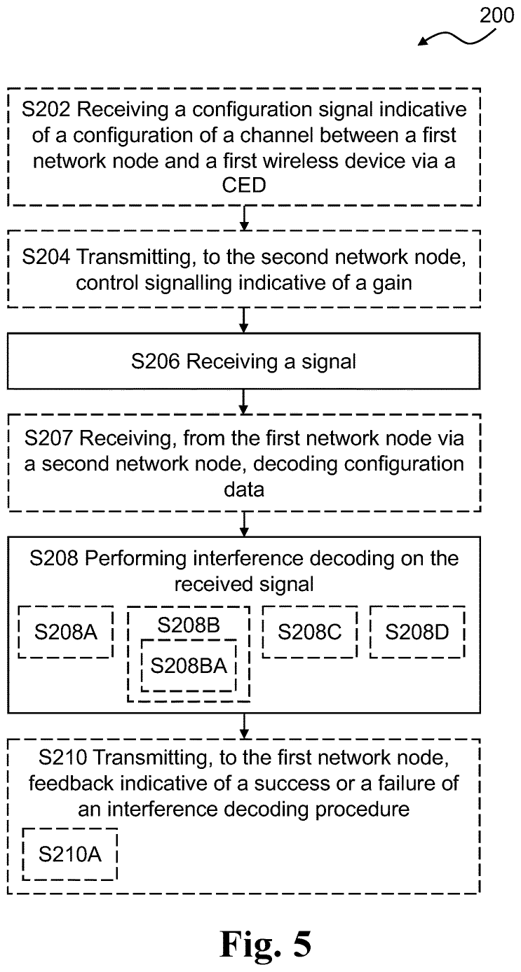

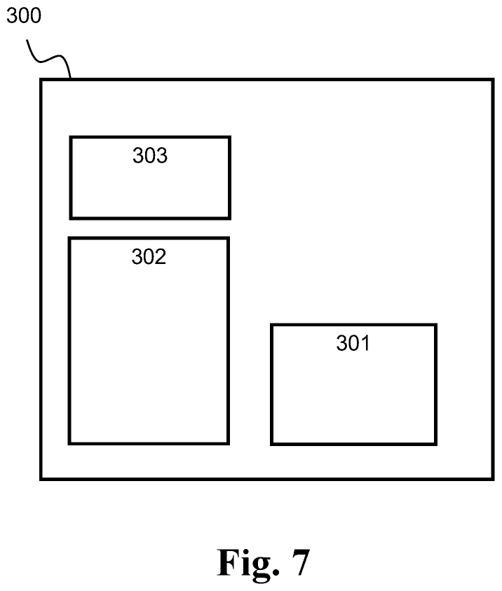

FIG. 5 shows a flow diagram of an example method 200, performed by a first wireless device (such as, wireless device 300 of FIGS. 1, 2, 3 and 7), for mitigating interference at the first wireless device. The interference is caused by a first signal (such as, signal s₁(t) of any of Equations 1, 2 and 3, first signal 516A) intended for a second wireless device (such as, wireless device 500 of FIGS. 1 and 2) served by a first network node (such as, network node 400 of FIGS. 1, 2, 4 and 6). In other words, the first signal comprises data intended for the second wireless device and can be used at the first wireless device for enabling interference decoding. The first wireless device is the wireless device disclosed herein, such as wireless device 300 of FIG. 1, FIG. 2, and FIG. 7.

The method 200 comprises receiving S206 a signal (such as, signal r₁(t) of Equation 1). The received signal is based on the first signal received from the first network node directly and via a coverage enhancing device, CED, and a second signal (such as, second signal 516B) received from a second network node (such as, network node 600 of FIG. 1). For example, the second signal is intended for the first wireless device. Stated differently, for example, the second signal comprises data intended for the first wireless device. The first signal may be seen as a signal from the first network node intended to the second wireless device but configured to enable interference decoding at the first wireless device. In one or more example methods, the first signal is intended for enabling interference decoding at the first wireless device and includes data intended for the second wireless device. In one or more examples, the interference is caused by the first signal comprising data intended for the second wireless device served by the first network node.

The received signal may result from the second signal being affected by the first signal (such as, the first signal interfering with the second signal at the first wireless device). The first signal may have been transmitted from the first network node using a first gain and via the CED using a third gain.

The method 200 comprises performing S208 interference decoding on the received signal by applying S208A an interference decoding procedure (such as, interference decoding procedure 512B of FIG. 2) to the received signal. In one or more examples, the interference decoding procedure may be illustrated in FIG. 3.

In one or more example methods, performing S208 the interference decoding procedure comprises obtaining S208B the first signal and the second signal by decoding S208BA the received signal. The first signal is part of interference. In one or more examples, the first wireless device is configured to decode the first signal by performing a first decoding procedure (such as, first decoding procedure 20 of FIG. 3) on the received signal. In one or more examples, the first wireless device is configured to decode the second signal after performing interference cancellation of the received signal for provision of an interference free signal (such as, signal \tilde{r}₁(t) of FIG. 3). The first wireless device may decode the second signal by performing a second decoding procedure (such as, first decoding procedure 40 of FIG. 3) on the interference free signal.

In one or more example methods, performing S208 the interference decoding procedure comprises cancelling S208C, based on the interference decoding, the first signal from the received signal. In one or more examples, the first wireless device is configured to decode and remove the first signal, such as an interfering component, from the received signal. The first wireless device may decode the second signal without the interference caused by the first signal. The second signal for example includes data intended to the first wireless device from the second network node.

In one or more examples, when a CED (such as, CED 800 of FIGS. 1 and 2) is activated for enabling interference mitigation at the wireless device, the first network node may establish and/or activate a channel between the first network node and the first wireless device via the CED (such as, third channel of FIGS. 4A-4B) with an increased gain (such as, γP_{CED}). The wireless device may be capable of decoding the second signal from the received signal when the first signal is associated with a transmit power sufficiently high for enabling interference decoding at the first wireless device. In other words, the interference caused by the first signal may be sufficiently high for the first wireless device to decode the first signal and remove the first signal from the received signal. The first wireless device may be then capable of decoding the second signal, such as the signal intended for the first wireless device.

In one or more example methods, the method 200 comprises receiving S207, from the first network node via the second network node, decoding configuration data. In one or more examples, the decoding configuration data comprises one or more of: the interference decoding procedure, an allocated resource, a modulation-and-coding scheme, and redundancy version. In one or more examples, this may correspond to S108 of FIGS. 4A-4B. In one or more example methods, performing S208 interference decoding on the signal comprises performing S208D, based on the decoding configuration data, the interference decoding procedure.

In one or more examples methods, the method 200 comprises receiving S202 a configuration signal indicative of a configuration of a channel between the first network node and the first wireless device via the CED. In one or more examples, this may correspond to S104 of FIGS. 4A-4B. In other words, the first wireless device may receive the configuration signal upon which the first network node configures the channel between the first network node and the first wireless device via the CED. In other words, the first wireless device can be informed that the first network node activates the channel between the first network node and the first wireless device via the CED (for example the third channel in some examples).

In one or more examples methods, the method 200 comprises transmitting S204, to the second network node, control signalling indicative of a gain associated with the channel between the first network node and the wireless device via the CED (such as, third gain 510 of FIG. 2, such as γP_{CED}). The first network node may use the gain for determining an interference mitigation procedure to be applied by the first wireless device for interference suppression, such as the interference decoding procedure. The first wireless device may be informed, by the first network node via the second network node, on the interference mitigation procedure to be applied by the first wireless device.

In one or more examples, the control signalling indicative of a gain associated with the channel between the first network node and the wireless device via the CED can be in form of a flag and/or one or more control messages. For example, the flag may be seen as an implicit signalling indicating to the second network node the gain associated with the channel between the first network node and the wireless device via the CED. For example, the one or more control messages can indicate to the second network node the gain associated with the channel between the first network node and the wireless device via the CED. For example, the one or more control messages can include information indicating to the second network node the gain associated with the channel between the first network node and the wireless device via the CED.

In one or more examples methods, the method 200 comprises transmitting S210, to the first network node, feedback indicative of a success or a failure of the interference decoding procedure. In one or more examples, this may correspond to S112 of FIGS. 4A-4B.

In one or more examples methods, transmitting S210 the feedback comprises transmitting S210A the feedback via the CED and/or via the second network node. In one or more examples, this may correspond to S112A of FIGS. 4A-4B.

Disclosed is a method performed by a network node, for enabling mitigation of interference at a first wireless device caused by a first signal intended for a second wireless device served by the network node via a second channel. The method comprises receiving an indication that the first wireless device experiences interference over a first channel; and activating, based on the indication, a third channel to the first wireless device that is different from the first channel (such as, in response to receiving the indication). In one or more example methods, the third channel is a channel between the network node and the first wireless device via a coverage enhancing device, CED. Disclosed is a network node configured for enabling mitigation of interference at a first wireless device. The interference is caused by a first signal intended for a second wireless device served by the network node. The network node comprises memory circuitry, processor circuitry, and a wireless interface. The network node is configured to receive (such as, via the wireless interface) an indication that the first wireless device experiences interference over a first channel; and activate (such as, via the processor circuitry), based on the indication, a third channel to the first wireless device that is different from the first channel (such as, in response to receiving the indication).

FIG. 6 shows a block diagram of an example network node 400 according to the disclosure. The network node 400 comprises memory circuitry 401, processor circuitry 402, and a wireless interface 403. The network node 400 may be configured to perform any of the methods disclosed in FIGS. 4A-4B. In other words, the network node 400 may be configured for enabling mitigation of interference at a first wireless device. The interference is caused by a first signal intended for a second wireless device served by the network node.

The network node 400 is configured to transmit (such as, via the wireless interface 403) the first signal to the first wireless device, using a first gain associated with a first channel between the network node and the first wireless device.

The network node 400 is configured to transmit (such as, via the wireless interface 403) the first signal to the first wireless device, via a coverage enhancing device, CED, using a third gain associated with a third channel between the network node and the first wireless device via the CED.

The network node 400 is configured to transmit (such as, via the wireless interface 403) the first signal to the second wireless device, using a second gain associated with a second channel between the network node and the second wireless device.

The first gain, the second gain, and the third gain are jointly determined by the network node 400.

The wireless interface 403 is configured to communicate using a wireless communication system with the second wireless device. In some examples, the wireless interface 403 is used for transmitting signal(s) that are configured to mitigate interference that may be experienced by the first wireless device (which may not be served by the network node 400). The wireless interface 403 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

Processor circuitry 402 is optionally configured to perform any of the operations disclosed in FIGS. 4A-4B (such as any one or more of: S102, S102AA, S102AB, S102C, S102D, S102E S104, S106, S108, S110, S112, S112A, S114, S114A, S114AA, S114AB, S114B). The operations of the network node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software. Memory circuitry 401 may be one or more of: a buffer, a flash memory, a hard drive, a removable media, a volatile memory, a non-volatile memory, a random access memory, RAM, and any other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 6). Memory circuitry 401 is considered a non-transitory computer readable medium.

Memory circuitry 401 may be configured to store the first signal, the second signal, the first gain, the second gain, the third gain, the feedback, the configuration of the CED, the decoding configuration data and/or control signalling indicative of interference level in a part of the memory.

FIG. 7 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 5. In other words, the wireless device 300 may be configured for mitigating interference at the first wireless device. The interference is caused by a first signal intended for a second wireless device served by a first network node.

The wireless device 300 is configured to receive (such as, via the wireless interface 303) a signal. The received signal is based on the first signal received from the first network node directly and via a coverage enhancing device, CED. The received signal is based on a second signal received from a second network node. The second signal is for example intended for the first wireless device. In other words, the second signal may comprise data intended for the first wireless device.

The wireless device 300 is configured to perform (such as, via the processor circuitry 302) interference decoding on the received signal by applying an interference decoding procedure to the received signal.

The wireless interface 303 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The wireless device 300 is optionally configured to perform any of the operations disclosed in FIG. 5 (such as any one or more of: S202, S204, S206, S207, S208, S208A, S208B, S208BA, S208C, S208D, S210, S210A). The operations of the wireless device 300 may be embodied in the form of executable logic routines (for example, lines of code, software programs, etc.) that are stored on a non-transitory computer readable medium (for example, memory circuitry 301) and are executed by processor circuitry 302.

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software. Memory circuitry 301 may be one or more of: a buffer, a flash memory, a hard drive, a removable media, a volatile memory, a non-volatile memory, a random access memory, RAM, and any other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 7). Memory circuitry 301 is considered a non-transitory computer readable medium.

Memory circuitry 301 may be configured to store the received signal, the interference decoding procedure, the decoding configuration data, the configuration signal, configuration of the CED, the control signalling indicative of a gain associated with the channel between the first network node and the wireless device via the CED, and/or the feedback in a part of the memory.

Examples of methods and products (network node and wireless device) according to the disclosure are set out in the following items:

Item 1. A method, performed by a network node, for enabling mitigation of interference at a first wireless device caused by a first signal intended for a second wireless device served by the network node, the method comprising:
transmitting (S110) the first signal,
to the first wireless device, using a first gain associated with a first channel between the network node and the first wireless device, and via a coverage enhancing device, CED, using a third gain associated with a third channel between the network node and the first wireless device via the CED, and
to the second wireless device, using a second gain associated with a second channel between the network node and the second wireless device;
wherein the first gain, the second gain, and the third gain are jointly determined.

Item 2. The method according to item 1, the method comprising:
receiving (S112), from the first wireless device, feedback indicative of a success or a failure of an interference decoding procedure for mitigating interference caused by the first signal; and
adjusting (S114), based on the feedback, the third gain.

Item 3. The method according to item 2, wherein adjusting (S114) the third gain comprises configuring (S114A) the CED upon receiving that the feedback indicates a failure of the interference decoding procedure.

Item 4. The method according to item 3, wherein configuring (S114A) the CED comprises selecting (S114AA) a beam pattern associated with the CED for enabling the interference decoding at the first wireless device.

Item 5. The method according to item 4, wherein configuring (S114A) the CED comprises increasing (S114AB) the third gain.

Item 6. The method according to any of items 2-5, wherein adjusting (S114) the third gain comprises decreasing (S114B) the third gain upon receiving that the feedback indicates a success of the interference decoding procedure.

Item 7. The method according to any of the previous items, the method comprising:
determining (S102) that interference experienced by the first wireless device over the first channel is stronger than the first signal received by the second wireless device over the second channel.

Item 8. The method according to item 7, wherein determining (S102) comprises comparing (S102A) the first gain with the second gain.

Item 9. The method according to item 8, wherein comparing (S102A) the first gain with the second gain comprises:
determining (S102AA) whether the comparison meets a first criterion; and
upon the comparison meeting the first criterion, determining (S102AB) that the interference experienced by the first wireless device over the first channel is stronger than the first signal received by the second wireless device over the second channel.

Item 10. The method according to any of items 8-9, the method comprising:
configuring (S104), based on the comparison, the third channel.

Item 11. The method according to any of the previous items, the method comprising determining (S106) jointly the first gain, the second gain, and the third gain.

Item 12. The method according to any of items 8-11 wherein determining (S102) comprises:
determining (S102B), based on the first gain, the second gain, and the third gain, a fourth gain associated with a spectral efficiency of the first wireless device and a spectral efficiency of the second wireless device.

Item 13. The method according to any of items 8-12, wherein determining (S102) comprises:
determining (S102C) whether the fourth gain meets a second criterion.

Item 14. The method according to item 13, wherein determining (S102) comprises:
upon determining that fourth gain meets the second criterion, selecting (S102D) the interference decoding procedure.

Item 15. The method according to any of items 13-14, wherein determining (S102) comprises:
upon determining that fourth gain does not meet the second criterion, selecting (s₁₀₂E) an interference mitigation procedure different from the interference decoding procedure.

Item 16. The method according to any of items 14-15, the method comprising:
transmitting (S108), to the first wireless device via a second network node serving the first wireless device, decoding configuration data, wherein the decoding configuration data comprises one or more of: the selected interference decoding procedure, an allocated resource, a modulation-and-coding scheme, and redundancy version.

Item 17. The method according to any of the previous items, wherein the network node and a second network node serving the first wireless device are part of a same node.

Item 18. The method according to any of items 2-17, wherein receiving (S112) the feedback comprises receiving (S112A) the feedback via the CED and/or the second network node.

Item 19. The method according to any of items 2-18, wherein determining (S106), jointly, a first gain, a second gain, and a third gain comprises using, as a reference value, a gain of a channel between the first wireless device and a second network node serving the first wireless device, wherein the channel between the first wireless device and the second network node is used to communicate a second signal in a same time period and a same set of frequency resources as the first signal is communicated.

Item 20. The method according to any of the previous items, wherein the first signal is intended for enabling interference decoding at the first wireless device and includes data intended for the second wireless device.

Item 21. A method, performed by a first wireless device, for mitigating interference at the first wireless device caused by a first signal intended for a second wireless device served by a first network node, the method comprising:
receiving (S206) a signal, wherein the received signal is based on the first signal received from the first network node directly and via a coverage enhancing device, CED, and a second signal received from a second network node, wherein the second signal comprises data intended for the first wireless device;
performing (S208) interference decoding on the received signal by applying (S208A) an interference decoding procedure to the received signal.

Item 22. The method according to item 21, wherein performing (S208) the interference decoding procedure comprises:
obtaining (S208B) the first signal and the second signal by decoding (S208BA) the received signal, wherein the first signal is part of interference;
cancelling (S208C), based on the interference decoding, the first signal from the received signal.

Item 23. The method according to any of items 21-22, the method comprising:
receiving (S207), from the first network node via the second network node, decoding configuration data, wherein the decoding configuration data comprises one or more of: the interference decoding procedure, an allocated resource, a modulation-and-coding scheme, and redundancy version.

Item 24. The method according to item 23, wherein performing (S208) interference decoding on the signal comprises:
performing (S208D), based on the decoding configuration data, the interference decoding procedure.

Item 25. The method according to any of items 21-24, the method comprising:
receiving (S202) a configuration signal indicative of a configuration of a channel between the first network node and the first wireless device via the CED.

Item 26. The method according to item 25, the method comprising:
transmitting (S204), to the second network node, control signalling indicative of a gain associated with the channel between the first network node and the wireless device via the CED.

Item 27. The method according to any of items 21-26, the method comprising:
transmitting (S210), to the first network node, feedback indicative of a success or a failure of the interference decoding procedure.

Item 28. The method according to item 27, wherein transmitting (S210) the feedback comprises transmitting (S210A) the feedback via the CED and/or via the second network node.

Item 29. A method performed by a network node, for enabling mitigation of interference at a first wireless device caused by a first signal intended for a second wireless device served by the network node via a second channel, the method comprising:
receiving (S302) an indication that the first wireless device experiences interference over a first channel; and
activating (S304), based on the indication, a third channel to the first wireless device that is different from the first channel.

Item 30. The method according to item 29, wherein the third channel is a channel between the network node and the first wireless device via a coverage enhancing device, CED.

Item 31. A network node comprising memory circuitry, processor circuitry, and a wireless interface, wherein the network node is configured to perform any of the methods according to any of items 1-20, and 29-30.

Item 32. A wireless device comprising memory circuitry, processor circuitry, and a wireless interface, wherein the wireless device is configured to perform any of the methods according to any of items 21-28.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that Figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware. Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a network node, for enabling mitigation of interference at a first wireless device caused by a first signal intended for a second wireless device served by the network node, the method comprising:
transmitting the first signal,
to the first wireless device, using a first gain associated with a first channel between the network node and the first wireless device, and via a coverage enhancing device (CED) using a third gain associated with a third channel between the network node and the first wireless device via the CED, and to the second wireless device, using a second gain associated with a second channel between the network node and the second wireless device;
wherein the first gain, the second gain, and the third gain are jointly determined.

2. The method according to claim 1, the method comprising:
receiving, from the first wireless device, feedback indicative of a success or a failure of an interference decoding procedure for mitigating interference caused by the first signal; and
adjusting, based on the feedback, the third gain.

3. The method according to claim 2, wherein adjusting the third gain comprises configuring the CED upon receiving that the feedback indicates a failure of the interference decoding procedure.

4. The method according to claim 3, wherein configuring the CED comprises selecting a beam pattern associated with the CED for enabling the interference decoding at the first wireless device.

5. The method according to claim 2, wherein adjusting the third gain comprises decreasing the third gain upon receiving that the feedback indicates a success of the interference decoding procedure.

6. The method according to claim 2, the method comprising:
determining that interference experienced by the first wireless device over the first channel is stronger than the first signal received by the second wireless device over the second channel.

7. The method according to claim 4, wherein
determining comprises comparing the first gain with the second gain.

8. The method according to claim 5, wherein comparing the first gain with the second gain comprises:
determining whether the comparison meets a first criterion; and
upon the comparison meeting the first criterion, determining that the interference experienced by the first wireless device over the first channel is stronger than the first signal received by the second wireless device over the second channel.

9. The method according to claim 5, the method comprising:
configuring, based on the comparison, the third channel.

10. The method according to claim 8, wherein determining comprises:
determining, based on the first gain, the second gain, and the third gain, a fourth gain associated with a spectral efficiency of the first wireless device and a spectral efficiency of the second wireless device.

11. The method according to claim 8, wherein determining comprises:
determining whether the fourth gain meets a second criterion.

12. The method according to claim 11, wherein determining comprises:
upon determining that fourth gain meets the second criterion, selecting the interference decoding procedure.

13. The method according to claim 11, the method comprising:
transmitting, to the first wireless device via a second network node serving the first wireless device, decoding configuration data, wherein the decoding configuration data comprises one or more of: the selected interference decoding procedure, an allocated resource, a modulation-and-coding scheme, and a redundancy version.

14. A method, performed by a first wireless device, for mitigating interference at the first wireless device caused by a first signal intended for a second wireless device served by a first network node, the method comprising:
receiving a signal, wherein the received signal is based on the first signal received from the first network node directly and via a coverage enhancing device (CED) and a second signal received from a second network node, wherein the second signal comprises data intended for the first wireless device;
performing interference decoding on the received signal by applying an interference decoding procedure to the received signal.

15. The method according to claim 14, wherein performing the interference decoding procedure comprises:
obtaining the first signal and the second signal by decoding the received signal, wherein the first signal is part of interference;
cancelling, based on the interference decoding, the first signal from the received signal.

16. The method according to claim 14, the method comprising:
receiving, from the first network node via the second network node, decoding configuration data, wherein the decoding configuration data comprises one or more of: the interference decoding procedure, an allocated resource, a modulation-and-coding scheme, and redundancy version.

17. The method according to claim 16, wherein performing interference decoding on the signal comprises:
performing, based on the decoding configuration data, the interference decoding procedure.

18. The method according to claim 14, the method comprising:
receiving a configuration signal indicative of a configuration of a channel between the first network node and the first wireless device via the CED.

19. The method according to claim 18, the method comprising:
transmitting, to the second network node, control signalling indicative of a gain associated with the channel between the first network node and the wireless device via the CED.

20. The method according to claim 14, the method comprising:
transmitting, to the first network node, feedback indicative of a success or a failure of the interference decoding procedure.
